(19) United States
(12) Patent Application Publication
(10) Pub. No.: US 2015/0329277 A1
(43) Pub. Date: Nov. 19, 2015

(54) PACKAGING UNIT FOR PRODUCTS LIKE EGGS, AND MOULD AND METHOD THERE FOR

(71) Applicant: HUHTAMAKI MOLDED FIBER TECHNOLOGY B.V., Franeker (NL)

(72) Inventor: Wybe DIJKSTRA, Dronrijp (NL)

(21) Appl. No.: 14/389,983

(22) PCT Filed: Apr. 2, 2013
(86) PCT No.: PCT/NL2013/050242

§ 371 Date: Oct. 1, 2014

(30) Foreign Application Priority Data
Apr. 2, 2012 (NL) 2008586
Jan. 24, 2013 (NL) 2010173

(51) Int. Cl. B65D 85/32; B65D 5/64; B65D 5/42; B65B 23/02; B65C 3/06

(52) U.S. Cl. CPC B65D 85/324; B65B 23/02; B65C 3/06; B65D 5/4233; B65D 5/4266; B65D 5/64

(57) ABSTRACT

A packaging unit for products like eggs, and a mould and method therefore. The packaging unit for products like eggs comprises:

a carton made of moulded pulp with a bottom part
comprising compartments for individual products, and a cover part comprising top, front and rear surfaces; and
a label made of paperboard, wherein the label comprises a label top surface that is attached to the top surface of the cover part, and a label front surface,

wherein the label front surface comprises a folding line dividing the label front surface in a first part and a second part such that in use the backs of the first and second parts engage each other.

### CROSS-REFERENCE TO RELATED APPLICATIONS

The present application is a U.S. National Phase filing of International Application No. PCT/NL2013/050242, filed on Apr. 2, 2013, designating the United States of America and claiming priority to and the benefit of NL 2008586, filed Apr. 2, 2012, and NL 2010173, filed Jan. 24, 2013. The present application claims priority to and the benefit of the above-identified applications, and the above-identified applications are incorporated by reference herein in their entirety.

### TECHNICAL FIELD

The present invention relates to a packaging unit for products like eggs and similar products like kiwis and tomatoes, for example.

### BACKGROUND

Egg cases or cartons known in practice are generally fabricated from carton made of moulded pulp from paper material. Such units comprise a bottom part provided with compartments for individual products, and a cover part that is often hingedly connected to the bottom part. Products like eggs are transported in these units and displayed on shelves in supermarkets, for example. Providing stacks of units with eggs leads to ridging problems. These ridging problems are even increased further due to the increasing stack height that is used in practice.

### BRIEF SUMMARY

The present invention has for its object to obviate or at least reduce the above stated problems with the known egg cases or cartons.

The present invention provides for this purpose a packaging unit for products like eggs, the packaging unit according to the invention comprising:

a carton made of moulded pulp with a bottom part comprising compartments for individual products, and a cover part comprising top, front and rear surfaces; and

a label made of paperboard, wherein the label comprises a label top surface that is attached to the top surface of the cover part, and a label front surface,

wherein the label front surface comprises a folding line dividing the label front surface in a first part and a second part such that in use the backs of the first and second parts engage each other.

### BRIEF DESCRIPTION OF THE DRAWINGS

FIG. 1 shows a hybrid pack embodiment of the packaging unit according to the present application in a closed position;

FIG. 2 shows the packaging unit of FIG. 1 in an open position;

FIGS. 3A and 3B show a cross-sectional view of the packaging unit of FIGS. 1 and 2;

FIGS. 4 and 5A show a packaging unit with an enforcing rib;

FIG. 5B shows an alternative embodiment with enforcing ribs;

FIGS. 6-8 show a triangular packaging unit;

FIG. 9 shows a denest nock;

FIGS. 10-11 show an alternative embodiment of the packaging unit according to the present application;

FIGS. 12-15 show an alternative embodiment of the packaging unit according to the present application in a closed position;

FIGS. 16-18 show the embodiment of FIGS. 12-15 in an open position;

FIGS. 19-20 show the plane of the label of the embodiment of FIGS. 12-18;

FIGS. 21-23 show the embodiment of FIGS. 12-18 when being handled;

FIGS. 24-26 show a further embodiment according to the present application; and

FIGS. 27 and 28 show some details of the embodiment shown in FIGS. 24-26.

### DETAILED DESCRIPTION

Certain embodiments of the present application are drawn to a packaging unit for products like eggs, the packaging unit according to the invention comprising:
a carton made of moulded pulp with a bottom part comprising compartments for individual products, and a cover part comprising top, front and rear surfaces; and
a label made of paperboard, wherein the label comprises a label top surface that is attached to the top surface of the cover part, and a label front surface,

wherein the label front surface comprises a folding line dividing the label front surface in a first part and a second part such that in use the backs of the first and second parts engage each other.

Using a label made of paperboard achieves an increased strength and stability for the unit without requiring modifications for the carton made of moulded pulp of paper material. This paperboard is defined for the purpose of the present invention as having a weight per surface area above 179 g/m², preferably above 250 g/m². The combination of the carton and the label made of paperboard enables an effective transport and display of products like eggs, and/or other perishable products like kiwis and tomatoes reducing ridging problems.

Additional advantages of the packaging unit according to the present invention include the (optional) provision of 3D-effects in the label, for example by embossing. In addition, the paperboard label can be cut, folded, laminated and/or printed. Preferably, the label has a thickness of more than 0.25 mm, more preferably more than 0.3 mm.

According to the invention the label comprises at least a label top surface that in use is attached to the top surface of the cover part, and a label front surface. The label front surface comprises a folding line dividing the label front surface in a first part and a second part. This provides the possibility to fold the first and second part relative to each other. In use the backs of the first and second parts engage each other. This provides additional strength and stability to at least the label front part. Preferably, the backs of the first and second parts are glued together. Joining these parts together has as a further advantage that the strength is further improved.

As an additional effect the label, at least the label front surface, requires only one-side-printing of the label. This reduces costs associated with two-sides-printing, while at the same time providing a print on both sides of at least the label front surface thereby improving the overall visual appearance of the packaging unit.

In a presently preferred embodiment of the packaging unit according to the invention the label material can be provided from a paperboard material having a weight per surface area in the range of 200-250 g/m². By folding back the second label front part sufficient strength and stability is provided to the label front part and the packaging unit as a whole.

In a presently preferred embodiment of the packaging unit according to the invention, the paperboard comprises folding carton.

Preferably, the weight of the folding carton lies between 200 and 600 g/m². In alternative embodiments, the paperboard comprises (mini) corrugated carton, for example.

The use of folding carton provides additional strength and stability to the packaging unit without requiring a significant increase in stacking height.

Preferably, the label is attached to at least the top surface of the cover part with the cover part preferably hingedly connected to the bottom part. This ensures a good visibility of the label for consumers. Also, by attaching the label to at least the top surface of the cover part the distribution of forces and loads acting on the cover part over the entire packaging unit is improved. This improves the overall stability of the unit. Preferably, the label is attached to essentially the entire top surface of the cover part thereby further improving the distribution of the forces and loads. These forces and loads may result from stacking packaging units, for example.

In a presently preferred embodiment of the packaging unit according to the invention the front surface of the bottom part comprises a protrusion. Preferably, this protrusion is provided on a hinged part. The label front surface comprises a corresponding opening such that the protrusion and the opening define a lock.

Providing a lock using a protrusion of the cover front surface and an opening in the label front surface the locking together of the bottom and cover of the packaging unit is improved. Furthermore, providing an opening for the lock in the label provides for a simplified design of the bottom of the packaging unit that is advantageous for manufacturing.

As a further advantage the label according to the invention can be provided with a larger, and higher, front surface. This enables providing more information and an improved visual appearance of the product. Due to the label being somewhat flexible the handling of the packaging unit is not hindered. This is especially so when the higher front label surface is combined with a somewhat lower cone in the bottom part of the packaging unit. This combination provides a good handling of the packaging unit with label on handling equipment, such as a denester and closing line. The same applies when the front surface of the label is provided with a folding line. Such folding line provides additional flexibility and enables a good handling of the packaging unit with a label in the handling equipment. Preferably, the edge of the packaging unit is rolled such that the label can be smoothly provided over the packaging unit.

In an advantageous preferred embodiment according to the present invention, the cover comprises openings such that the back side of the label is visible and readable from the inside of the cover part.

The openings in the cover part, especially openings in the top surface of the cover part, form “windows” such that the back side of the label can be read from the inside of the cover part. This prevents providing an additional label or print on the inside of the cover part. Such additional label may comprise information relating to the contents of the products in the packaging unit and production and/or packaging dates.

An additional advantage of providing openings in the cover part is that the amount of material required for the cover part, and especially the top surface thereof, is reduced. By carefully selecting the position of these openings the strength and stability of the packaging unit can be maintained. In fact, in combination with the label according to the present invention, the strength and stability of the packaging unit as a whole is even increased. By requiring less material for the cover part, the packaging unit according to the present invention is relatively cost effective. In an alternative embodiment no text is printed on the back side of the label and, instead, the label is transparent such that consumers may inspect the products visually without opening the packaging unit.

In an advantageously preferred embodiment according to the present invention the cover part comprises an indent such that the support of the front surface of the packaging unit is improved.

Providing an indent in the cover part, more specifically on the edge where the top surface and the front surface of the cover part meet each other, achieves an increased stability for the packaging unit according to the invention. More specifically, the stability is increased in the manufacturing process of the packaging unit. A problem when manufacturing packaging units is the removal of the moulded fibre material from the mould when the material is still wet. In this wet phase sides and/or the front of the packaging unit may collapse, for example. By providing an indent in the cover part the height of the front of the cover part is reduced and the stability of the cover is increased. Therefore, the risk of collapsing of this surface is significantly reduced.

Preferably, the indent is egg shaped. Providing an egg shaped indent achieves an improved load distribution and/or transmission of forces. This reduces the peak loads that may act on the packaging unit. An additional advantage is the visual appearance of the packaging unit in case the packaging unit according to the present invention is used for eggs, for example. Preferably, the indent is used in combination with the label made of folding carton with the label having a top surface and a front surface, thereby contributing to the transmission of forces and reduction of peak loads.

In a further advantageous preferred embodiment of the present invention, the label comprises an extended front surface.

By providing an extended front surface for the label the front surface of the cover part can be reduced.

This provides the above mentioned advantages when manufacturing the packaging unit in the wet phase by reducing the risk of collapsing of the front surface of the cover part. An additional advantage of providing an extended front surface is the overall visual appearance, especially when the packaging unit is displayed on a shelf of a supermarket.

Preferably, the extended front surface comprises a folding line. Such folding line can be provided in a relatively straightforward manner when the label is made of folding carton. By providing a folding line the controllability of processing of the packaging unit is improved as the front surface is more flexible. For example, this would be beneficial in a grading and packing machine or line, especially for denesting the packaging units. In addition, the packaging units are provided with a label comprising an extended front surface can be put in an outer box in a similar manner as conventional packaging units thereby using outer boxes of similar dimensions.

Preferably, the extended front surface comprises a groove, opening or notch corresponding to a projection provided on the bottom part such that a lock is achieved. Providing the groove, opening or notch in the front surface of the label achieves a lock in combination with a projection that is provided on the bottom part of the unit. This projection can be shaped like a nock, edge, etc. Providing at least part of the locking mechanism in the extended front surface of the label simplifies the manufacturing of the packaging unit, especially the front surface of the cover part thereof. By providing the label from folding carton an effective lock can be achieved. A further advantage can be achieved if the closing flap on the moulded fiber bottom part can be omitted by providing the label as an effective lock. This reduces weight of the packaging unit. Also, the dimensions of the packaging unit are reduced thereby reducing transport volume.

In a further advantageous preferred embodiment according to the present invention, the top surface of the cover part comprises enforcing ribs.

Providing enforcing ribs on especially the inner side of the top surface of the cover part improves the distribution of forces and loads over the packaging unit. For example when stacking a number of packaging units, the loads and especially the peak loads can be relatively high. These peak loads may result in ridging problems. These ridging problems include dents, dimples and other deformations. In practice these deformations provide a type of wave pattern on the top surface of the cover part. In fact, due to peak loads an undesired print of the bottom of a packaging unit is made on the top surface of a packaging unit placed directly below. By providing the enforcing ribs such ridging problems are prevented or at least reduced. In addition, providing the ribs improves the stability of the packaging units.

Preferably, the enforcing ribs are provided on a location of the cover part such that the ribs engage support cones of the bottom part in a closed position of the unit. The packaging unit is subjected to forces and loads especially in a closed position. By providing the ribs in a location such that the ribs engage the support cones of the bottom part in a closed position of the packaging unit the distribution of forces and loads is improved even further. This significantly increases the strength and stability of the packaging units according to the invention.

In addition, or as an alternative, the enforcing ribs are provided at or on the inner side of the cover part, preferably around each product position. This increases the stability of the packaging unit. An embodiment with ribs around a product position would enable the provision of individual windows in the cover part and label for a single product. This increases the visibility of the product for consumers, for example.

Advantageously, the enforcing ribs also contribute to denesting packaging units.

In a presently preferred embodiment at least part of the enforcing ribs is formed by a label part. Providing enforcing ribs from a label part prevents the use of additional material and, therefore, results in effective packaging units. Preferably the enforcing ribs are made from folding carton. Alternatively, the enforcing ribs are made from (micro) corrugated cardboard.

In a presently preferred embodiment according to the present invention, the ribs extend from the front surface of the cover to the rear surface of the cover. This improves the strength and stability of the cover. Optionally, ribs extend from either front or rear surface to a window that is provide in the cover.

Preferably, the ribs rest on the tops of the cones provided in the bottom of the packaging unit. This further improves the strength of the packaging unit as a whole, and provides an anti-ridging effect. Also, the height of the cones may be reduced. This improves the manufacturing ability of the packaging unit according to the invention. In addition, the ribs have a denesting effect thereby improving the handling of the packaging units.

In a further advantageous preferred embodiment according to the present invention the cover part comprises support elements that in a closed position of the packaging unit engage corresponding support elements provided on the bottom part.

By providing support elements on the cover part, preferably on the corners of the cover part, additional support is achieved by providing corresponding support elements on the bottom part. This improves the support especially on the front side with the locking mechanism of packaging unit. The support elements can be provided as ribs, indents, protrusions, profiled edges etc.

In a further advantageous preferred embodiment according to the present invention, the cover part comprises denest nocks.

Providing denest nocks in the cover part improves the ease of use of the packaging unit when denesting these units. The use of the denest nocks is improved as the combination with the label according to the present invention prevents introduction of ridging problems as occurs in conventional packaging units.

The present invention further relates to a mould for packaging units as described above.

Such a mould provides the same effects and advantages as described in respect of the packaging unit. An additional advantage of the packaging unit according to the present invention is that the mould can be designed such that further changes or modification to the machinery are prevented. This results in a flexible manufacturing process of the packaging unit according to the present invention.

The present invention further also relates to a method for packing products, comprising the step of providing a packaging unit as described above.

Such a method provides the same effects and advantages as described in respect of the packaging unit and/or mould. In fact, the mould can be used for a large number of different embodiments of the packaging unit according to the invention. This improves the overall efficiency of the manufacturing process.

Further advantages, features and details of the invention are elucidated on the basis of preferred embodiments thereof, wherein reference is made to the accompanying drawings.

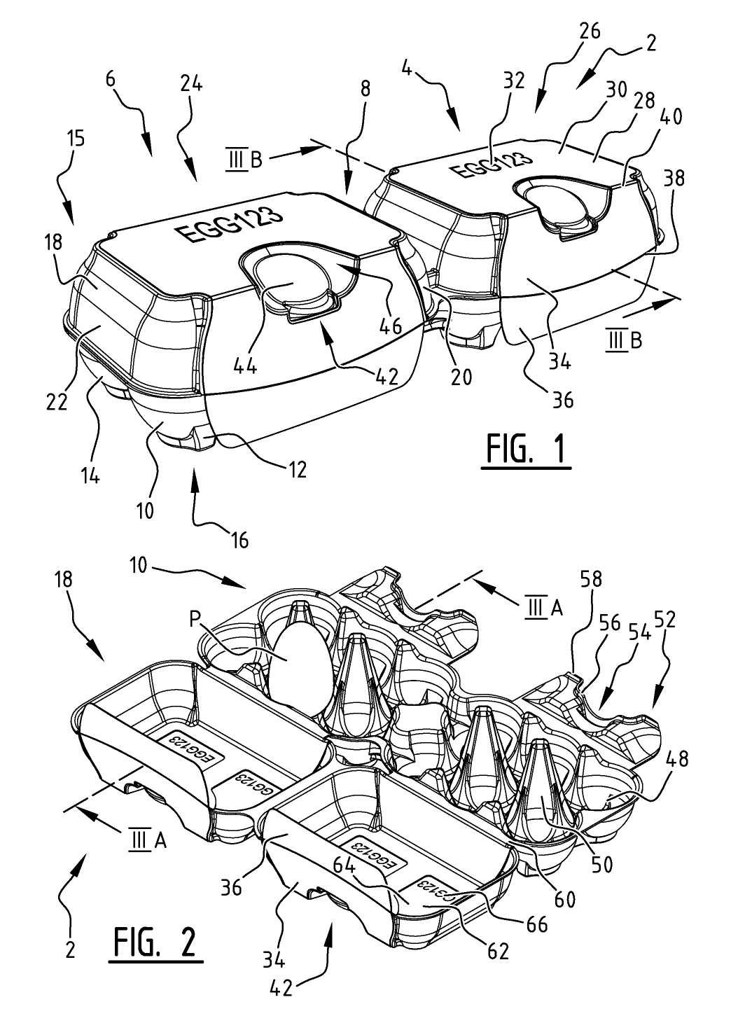

A hybrid pack 2 (FIG. 1) comprises a first packaging unit 4 and a second packaging unit 6 according to the invention. First and second packaging units 4, 6 are connected with a bridging part 8. Bottom part 10 comprises a front surface 12, two side surfaces 14, a back side 15, and a bottom side 16. Cover part 18 is hingedly connected to bottom part 10 and comprises a front surface 20, two side surfaces 22, a back side surface 24 and a top surface 26. Packaging units 4, 6 are provided with a label 28 that is provided with a top surface 30 on which text 32 is printed.

In the illustrated embodiment label 28 is provided with a front surface 34, and an extended part 36 for front side 34. Extended part 36 and front surface 34 are connected with folding line 38. Edge 40 defines the transition between top surface 30 and front surface 34. Packaging units 4, 6 are provided with an indent 42 having an egg-shape 44. In the illustrated embodiments label 28 is provided with corresponding cut-out 46.

On the inside of bottom part 10 (FIG. 2) compartments 48 are provided having contours matching at least partially the outer contours of eggs P. Support cones 50 are provided to add stability and strength to packaging units 4, 6. Lip 52 is hingedly connected to front surface 12 of bottom part 10 and is provided with a cut-out 54. Along the edge of cut-out 54 there is provided a support edge 56 for distributing loads. In addition, a support nock 58 is provided. Cover part 18 and bottom part 10 are hingedly connected via hinge 60. Cover part 18 is provided with a window opening 62 through which the back side 64 of label 28 is visible. In the illustrated embodiment back side 64 of label 28 is provided with text and/or images 66. Alternatively, label 28 is provided with transparent material for window opening 62.

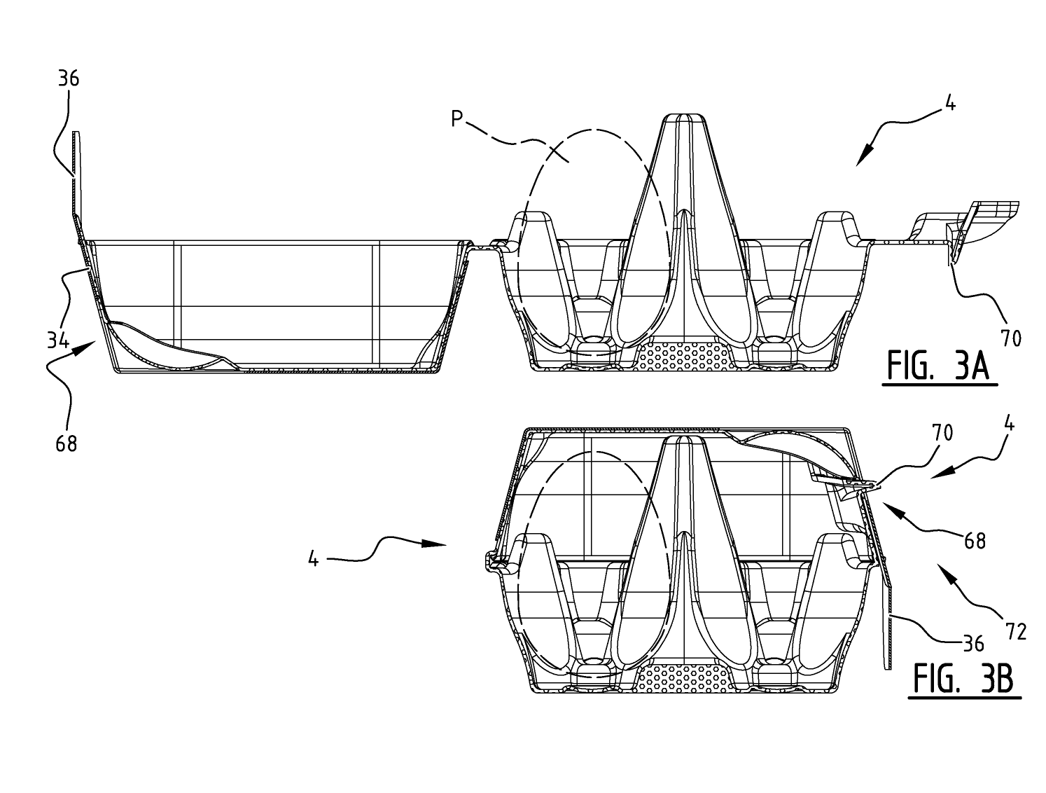

Front 20 of cover part 18 is provided with edge, protrusion, or projection 70 (FIGS. 3A and B) that fits in notch 68 that is provided in front surface 34 of label 28 together providing lock 72 that can be provided in the label and/or the moulded fiber material.

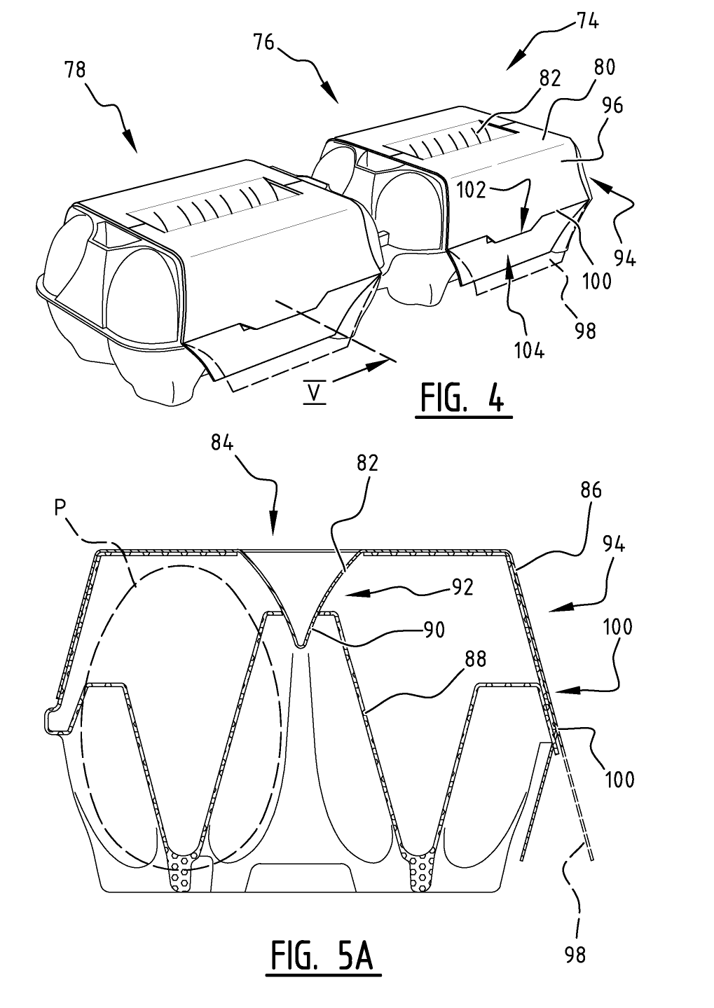

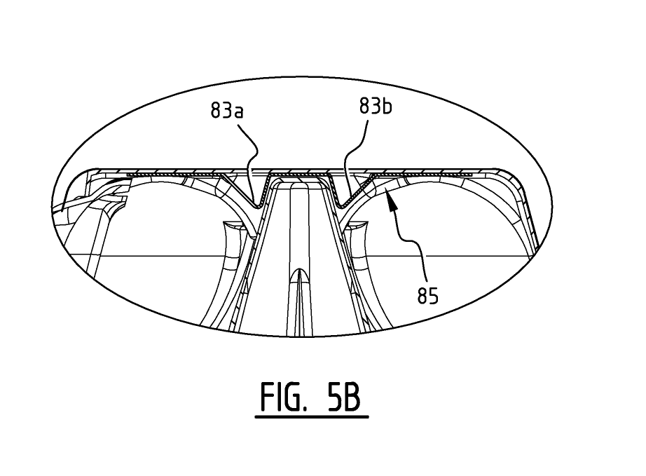

Hybrid pack 74 (FIGS. 4 and 5A) comprises a first unit 76 and a second unit 78. Label 80 provides enforcing rib 82. In a closed position rib 82 is located in an opening 84 in cover part 86 and engages support cone 88. Rib 82 can be provided with text and/or images. In an alternative embodiment two ribs 83a, 83b (FIG. 5B) are provided on a profiled inside label 85. Providing two ribs 83a, 83b additionally has a centring function such that the overall stability in a closed position of the packaging unit is improved. It is noted that also hybrid pack 74 can be provided with two ribs 82 (not shown) thereby also providing the above centring function. A profiled inside label 85 with one, two, or more ribs 83a, 83b can also be applied to conventional packaging units.

In the illustrated embodiment top 90 of rib 82 engages opening 92 provided in the top surface of support cone 88. This provides additional support for cover 86 thereby protecting products P in hybrid pack 74. Label 80 has a front surface 94 that is provided with an upper part 96 and a lower part 98 that are connected via folding line 100. Front surface 94 is provided with a notch or groove capable of forming a lock in a closed position of hybrid pack 74.

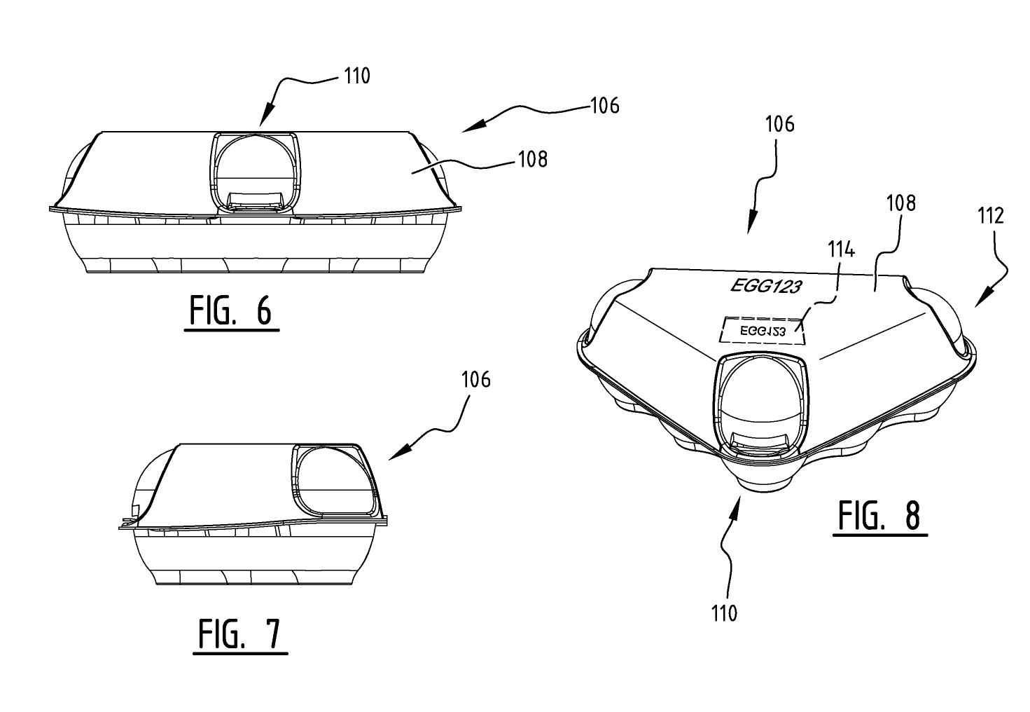

A triangular shaped packaging unit 106 (FIG. 6-8) is provided with a label 108, an egg-shaped indent 110, and an opening 114 in cover part 112. Unit 106 can be combined with one or more of the features described and illustrated for the rectangular shaped unit 2, thereby achieving most of the above described advantages in relation to the packaging unit according to the present invention.

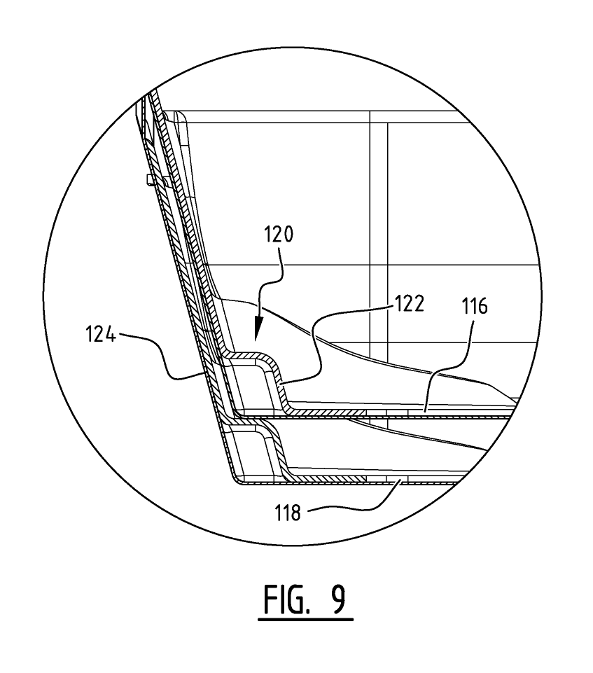

For denesting a first packaging unit 116 from another packaging unit 118 (FIG. 9) denesting nocks 120 are provided. In the illustrated embodiment nocks 120 are shaped as indents 122 in the moulded fiber material with the label 124 extending over indent 122. Preferably, label 124 covers indent 122 on the outside of packaging units 116, 118. In the illustrated embodiment the stacking height is in the range of 7-7.5 mm. This stacking height essentially is the distance between the covers of the packaging units 116 and 118.

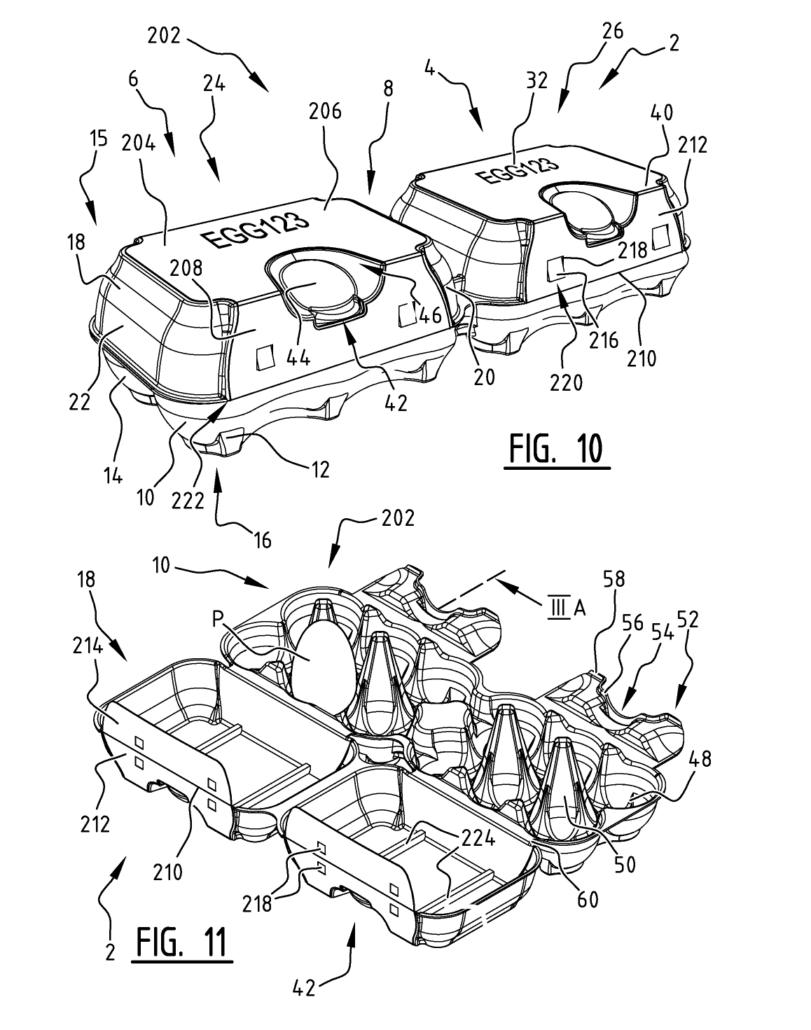

Packaging unit 202 (FIGS. 10 and 11) is provided with bottom part 10 and a cover part 18. In the illustrated embodiment unit 202 comprises a first unit 4 and second unit 6. The same or similar features of packaging unit 202 as compared to the embodiments described earlier (FIGS. 1-9) are shown with the same reference signs and/or can be applied in similar manner.

Label 204 is provided with a label top surface 206 and a label front surface 208. Surface 208 is provided with folding line 210 dividing surface 208 in first part 212 and second part 214. In the illustrated embodiment the hinged part of bottom 16 is provided with two protrusions 216 and label 204 is provided with two corresponding openings 218 together defining lock 220. Edge 222 adjacent to front surface 208 of label 204 is rolled or flattened to improve the overall appearance.

Furthermore, the illustrated packaging unit 202 is provided with enforcing ribs 224 on the inside of cover part 18. Ribs 224 extend from cover front surface 20 to back side surface 24 and in a closed position partly rest on cones 50.

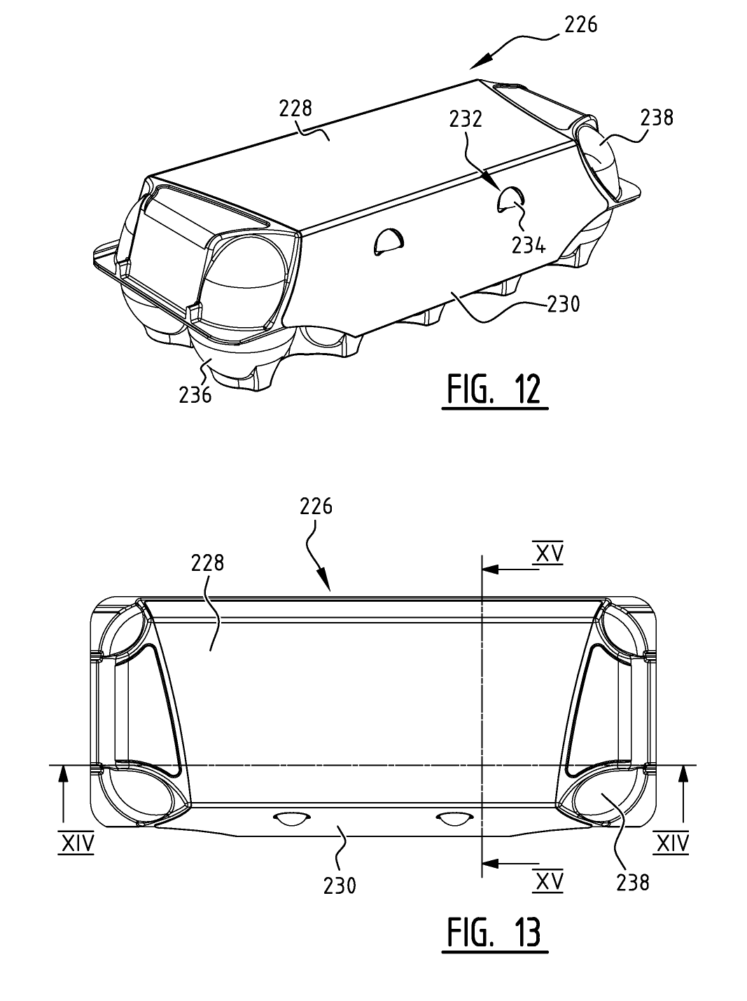

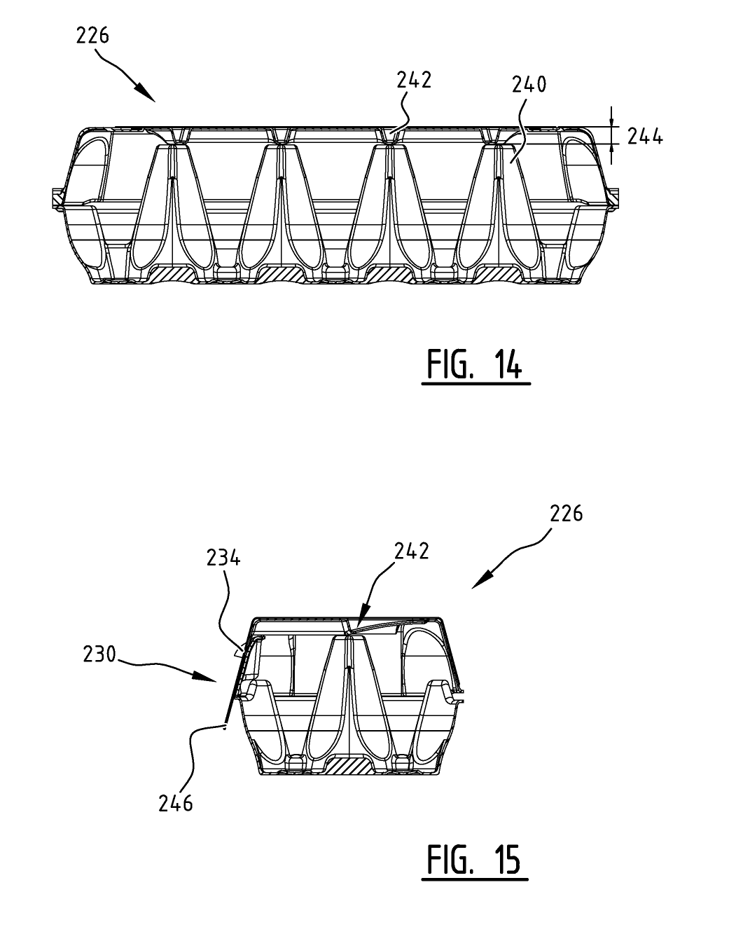

Packaging unit 226 (FIGS. 12-18) is provided with label 228. In the illustrated embodiment front surface 230 is provided with two openings 232 (FIGS. 12-13) corresponding to two protrusions 234 provided on the hinged part of bottom part 236 of unit 226. Unit 226 is provided with egg-shaped corners 238. In the closed position cone 240 rests on edge or rib 242 (FIGS. 14-15). As compared to more conventional packaging units cone 240 has a reduced height 244. This is advantageous when manufacturing and handling unit 226. Front surface 230 of label 228 has an extended part 246. Edge or rib 242 also improves anti-ridging of unit 226.

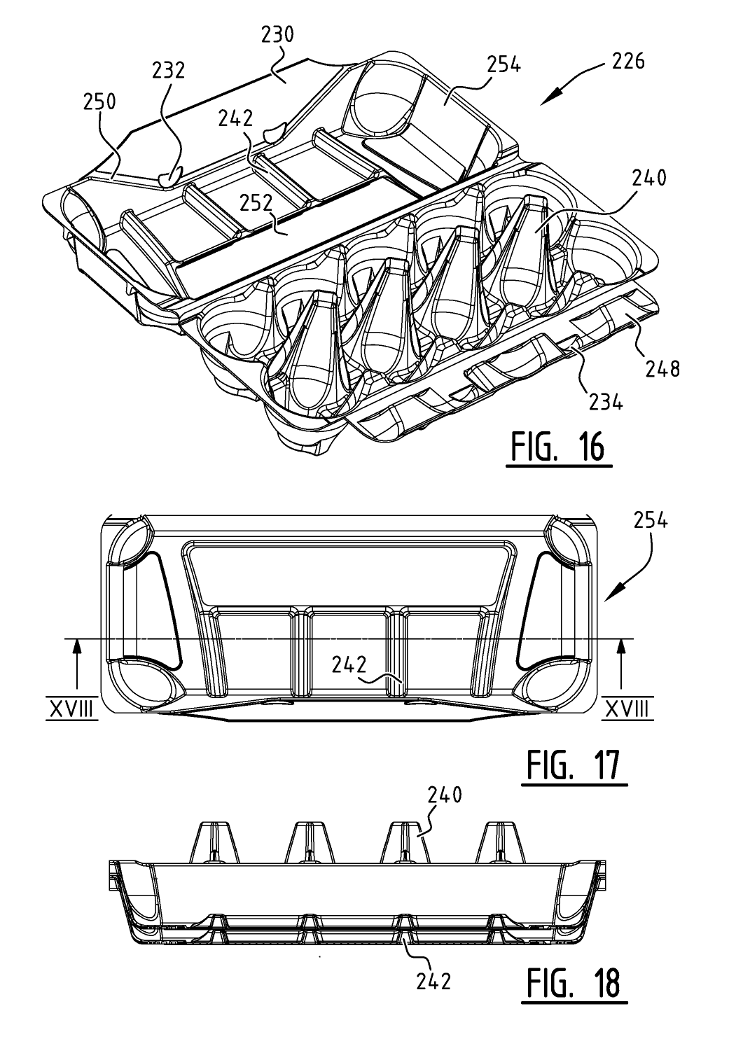

In an open position of unit 226 (FIGS. 16-18) hinged part 248 of bottom part 236 is provided with protrusions 234. Front surface 230 of label 228 is provided with openings 232. In the illustrated embodiment openings 232 and protrusions 234 are positioned at or adjacent to rolled edge 250 (FIG. 16). Edges or ribs 242 extend in a front to back direction. In the illustrated embodiment a window 252 is optionally provided in cover part 254. Edges or ribs 242 preferably are U-shaped (FIGS. 17-18) and provide a denesting or spacer function in the open position.

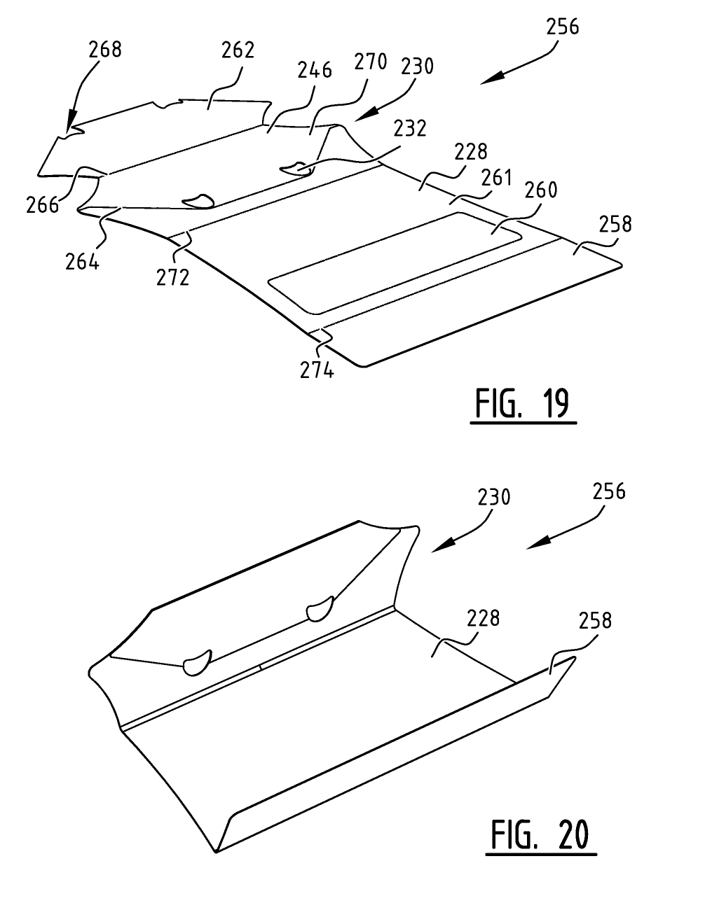

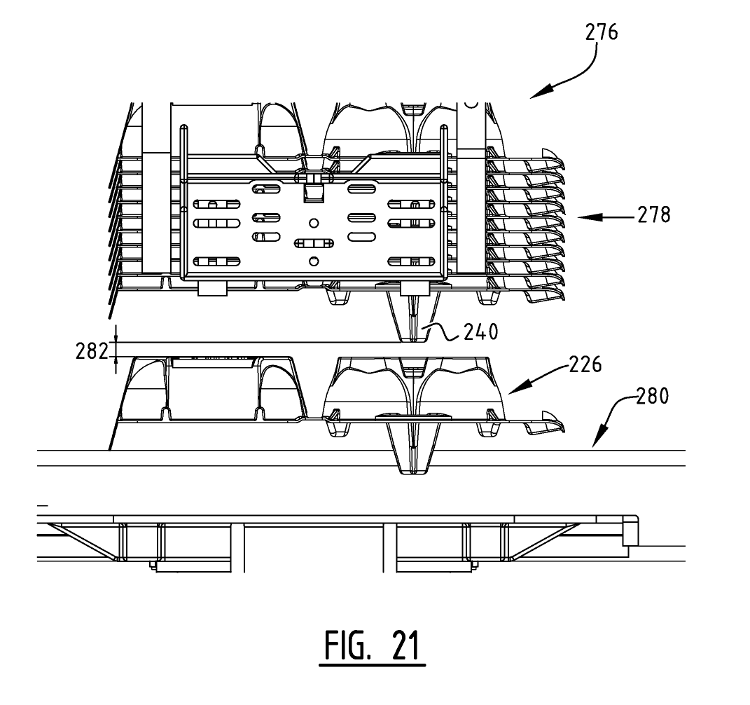

Blank 256 (FIGS. 19-20) for label 228 comprises a back part 258. Optionally, window or opening 260 is provided in top part 261. Front surface 230 is provided with openings 232. Extended part 246 is connected to second part 262 of front surface 230 by folding line 266. In the illustrated embodiment notches 268 are provided that engage openings 232 when second part 262 and first part 270 of front surface 230 are joined together such that second part 262 reaches line 264. In use blank 256 is folded over folding lines 266, 272, 274.

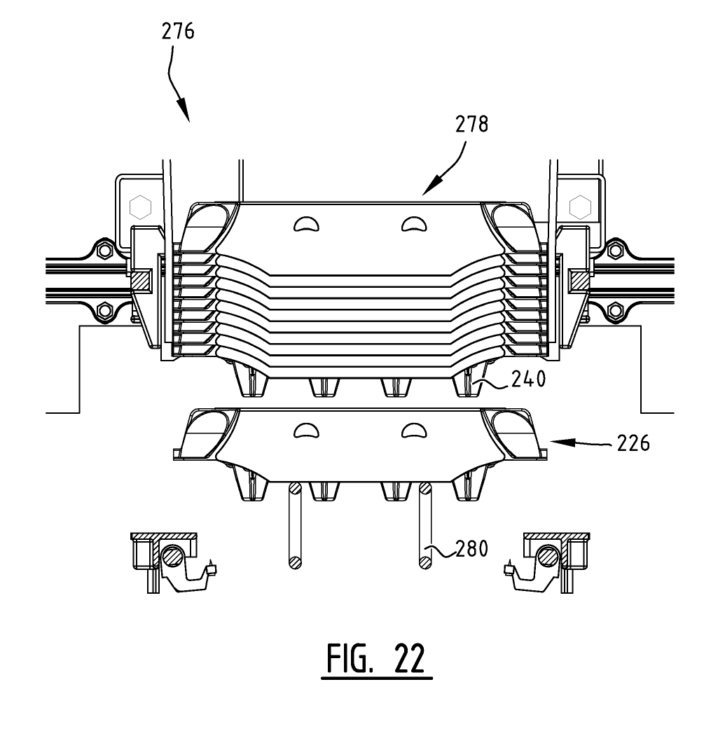

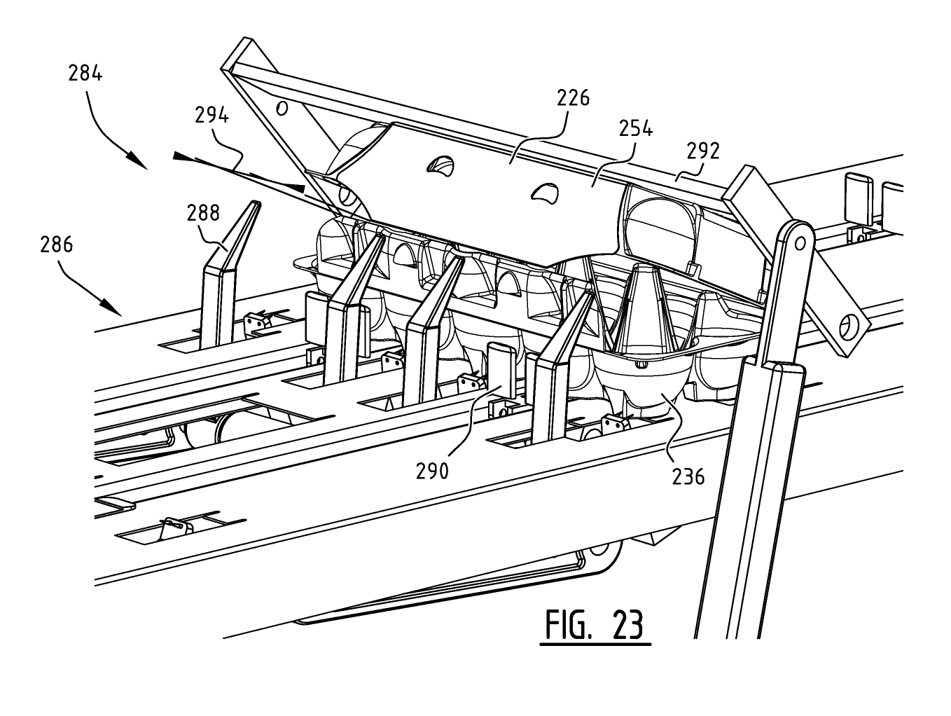

When handling packaging units 226 a denesting line 276 (FIGS. 21-22) provides a stack 278 of units 226. A unit 226 is taken from stack 278 and transported by transport means 280. Distance 282 between stack 278 and unit 226 is one of the factors determining the operational performance of line 276. In the illustrated embodiment the height of cone 240 is reduced in combination with providing edges or ribs 242. This enlarges distance 282.

Closing line 284 (FIG. 23) transports units 226 with transport means 286. For performing a closing operation unit 226 is engaged by arms 288 and blocking members 290. Cover 254 is positioned over bottom part 236 with folding member 292. The combination of edges or ribs 242, the double-layered front surface 230 of label 228 such that hinged part 248 of bottom part 236 has a reduced height, and the height reduction of cone 240, provides more flexibility for closing line 284 with an optimal distance 294 between hinged part 248 and front surface 230. In addition, this improved flexibility is achieved while maintain the support function. In fact, using rib 242, partly engaging cone 240, further improves the support.

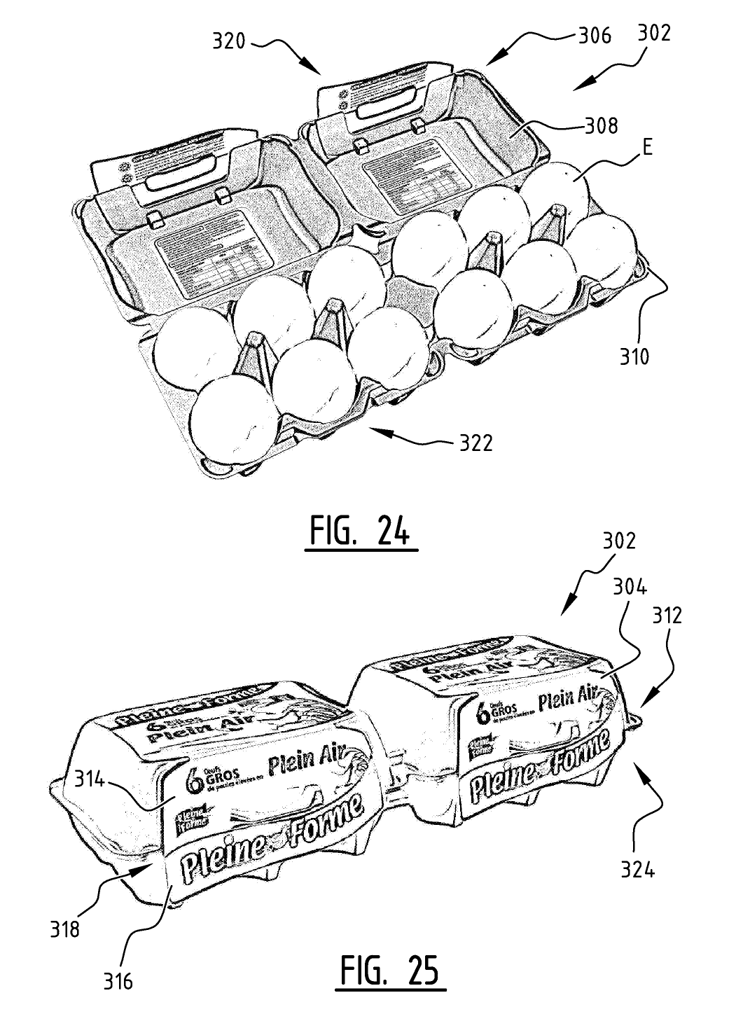

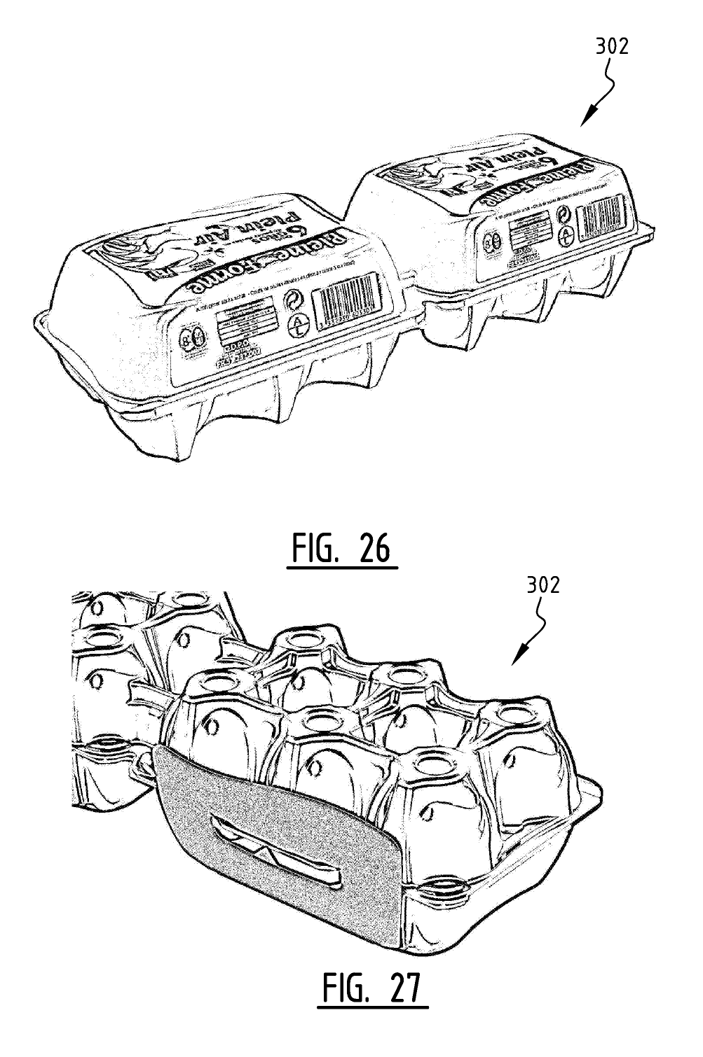

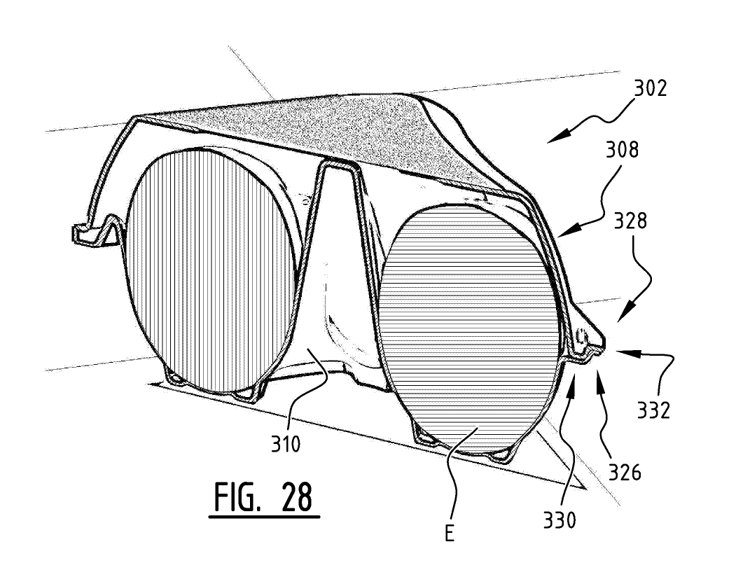

In an alternative packaging unit 302 (FIGS. 24-28) label 304 is provided. Window 306 is provided in cover part 308 similar to embodiments described earlier. Eggs E can be placed in bottom part 310. Front surface 312 of label 304 is provided with a first part 314 and second part 316 separated by folding line 318. Opening 320 in label 304 provides closing functionality together with edge 322 that is provided on bottom part 310. Opening 320 and edge 322 provide a locking mechanism 324 without requiring the need for a separate lip or closing part. Optionally, by obviating the need for the separate lip or closing part the label material can be provided from a thicker material without increasing the total weight of packaging unit 302. Further advantages of omitting lip or closing part is the reduced complexity in handling and transport of packaging unit 302. In addition, by providing opening 320 with a (partly) increased height a visual effect is achieved. For example, this enables the consumer to actually view the eggs inside the packaging without opening it.

In the illustrated embodiment packaging unit 302 is provided with supports 326 on the corners 328 of cover part 308. Support 326 is achieved by providing a profiled edge 330 on bottom part 310 and a corresponding profiled edge 332 on cover part 308. This improves the support especially on the front side with locking mechanism 324 of packaging unit 302.

The present invention is by no means limited to the above described preferred embodiments thereof. The rights sought are defined by the following claims, within the scope of which many modifications are possible. It is thus possible for instance to apply one or more of the features described in relation to the present invention in conventional packaging units. As an example, it is possible to use the egg-shaped indent in conventional packaging units without the use of the label according to the present invention. Furthermore, dimensions of openings, windows etc. can be designed depending on product characteristics, marketing information and/or consumer preferences, for example.

1. Packaging unit comprising:
a carton made of moulded pulp, wherein the carton comprises a bottom part comprising compartments for individual products, and a cover part comprising a top surface, a front surface and a rear surface; and
a label made of paperboard, wherein the label comprises
a label top surface that is attached to the top surface of the cover part, and
a label front surface, wherein the label front surface comprises a folding line dividing the label front surface into a first part and a second part such that a back part of the first part and a back part of the second part are capable of engaging each other.

2. Packaging unit according to claim 1, wherein the paperboard comprises folding carton.

3. Packaging unit according to claim 1, wherein the paperboard has a weight in the range of 200-250 g/m².

4. Packaging unit according to claim 1, wherein a front surface of the bottom part comprises a protrusion and the label front surface comprises a corresponding opening such that the protrusion and the opening define a lock.

5. Packaging unit according to claim 1, wherein the cover part comprises one or more openings such that a back side of the label is visible from an inside of the cover part.

6. Packaging unit according to claim 1, the cover part comprising an indent such that a front surface of the packaging unit is supported.

7. Packaging unit according to claim 6, wherein the indent is egg-shaped.

8. Packaging unit according to claim 1, wherein the label comprises an extended front surface.

9. Packaging unit according to claim 8, wherein the extended front surface of the label comprises a folding line.

10. Packaging unit according to claim 8, wherein the extended front surface of the label comprises a groove, opening or notch corresponding to a projection provided on the bottom part such that a lock can be achieved.

11. Packaging unit according to claim 1, wherein the top surface of the cover part comprises enforcing ribs.

12. Packaging unit according to claim 11, wherein the enforcing ribs are provided on a location of the cover part such that the ribs engage support cones of the bottom part in a closed position of the packaging unit.

13. Packaging unit according to claim 11, wherein at least part of the enforcing ribs is formed by a label part.

14. Packaging unit according to claim 1, wherein the ribs extend from the front surface of the cover to the rear surface of the cover.

15. Packaging unit according to claim 1, wherein the cover part comprises support elements that in a closed position of the packaging unit, engage corresponding support elements provided on the bottom part.

16. Packaging unit according to claim 1, wherein the cover part comprises denest nocks.

17. A mould for a packaging unit according to claim 1.

18. Method for packing products, said method comprising the step of providing a packaging unit comprising:
a carton made of moulded pulp, wherein the carton comprises
a bottom part comprising compartments for individual products. and
a cover part comprising a top surface, a front surface and a rear surface; and
a label made of a c board wherein the label comprises
a label top surface that is attached to the top surface of the cover part, and
a label front surface, wherein the label front surface comprises a folding line dividing the label front surface into a first part and a second part such that a back part of the first part and a back part of the second part are capable of engaging each other.

19. Packaging unit according to claim 1, wherein the individual products are eggs.

20. Method for packing products according to claim 18, wherein the individual products are eggs.
